(19) United States
(12) Patent Application Publication
(10) Pub. No.: US 2025/0122934 A1
(43) Pub. Date: Apr. 17, 2025

(54) Hydraulic Drive System and Method for Producing the Hydrostatic Drive System

(71) Applicant: HMS--Hybrid Motion Solutions GmbH, Rutesheim (DE)

(72) Inventors: Achim HELBIG, Stuttgart (DE); Frank SOEHNEL, Stuttgart (DE); Jan RANTA, Stuttgart (DE)

(21) Appl. No.: 18/887,067

(22) Filed: Sep. 17, 2024

(30) Foreign Application Priority Data
Oct. 13, 2023 (DE) 102023128095.3

(51) Int. Cl. F16H 61/46; F16H 47/02

(52) U.S. Cl. CPC F16H 61/46; F16H 47/02

(57) ABSTRACT

A hydrostatic drive system, and methods of making and using same, including a constant pump configured to provide at least two and at most three pumping states for pumping a corresponding volume flow. A switching device has a switching valve and a switching member, wherein a switching pressure is provided via the switching valve for switching the switching member, and wherein the switching member is configured, on the basis of the switching pressure, to switch the constant pump into one of the pumping states and to provide the corresponding volume flow to the hydraulic cylinder.

### CROSS-REFERENCE TO RELATED APPLICATION

This application claims priority to German Patent Application No. 102023 128095.3 filed 13 Oct. 2023. The entire contents of the above-mentioned application are incorporated herein by reference as if set forth herein in entirety.

### FIELD OF THE INVENTION

This invention relates to hydrostatic drive systems having at least one hydraulic cylinder with cylinder surfaces, and methods of producing and using same.

### BACKGROUND OF THE INVENTION

Hydraulic drive systems may include two- or four-quadrant pumps such as 2Q-constant pumps in combination with a changeover valve, 2Q-variable displacement pumps in combination with a changeover valve or 4Q-variable displacement pumps as a corresponding drive system. The aforementioned drive systems can be provided in hydraulically driven pressure boosters for compressing fluids, comprising gases or liquids.

A drive system having a 2Q-constant pump in combination with a changeover valve can be characterized by high dynamics and a low-cost factor. This drive system, however, is disadvantageous when providing the desired volume flows since it can only provide a maximum volume flow in the respective direction to be actuated (±Qₘₐₓ) for a pressure booster. Throttling flow losses can also occur in the changeover valve and potentially no-load losses in the drive system. Moreover, the possibility of energy recovery is not provided. In addition, the drive system with a 2Q-constant pump and changeover valve is disadvantageous in that the constant volume flow is switched via a changeover valve (switching valve) to the A side or the B side of a pressure booster which can lead to impacts and/or vibrations in a corresponding facility. This results in such facilities having significant noise emissions and a limited service life.

The associated drawback of impacts and/or vibrations of the drive system with a 2Q-constant pump in combination with a changeover valve can be reduced by a drive system with a 2Q-variable displacement pump in combination with a changeover valve. By means of such a drive system, a volume flow can be adapted via a proportional displacement device. At a constant motor speed, the pumping volume of the 2Q-variable displacement pump can be selected arbitrarily, comprising a continuous displacement of 0 to Vₘₐₓ. Thus, the volume flow can be adapted and volume flow ramps (0 to Qₘₐₓ) produced. Any volume flow can be activated. The changeover valve used in this solution of the drive system can be used to switch the variable volume flow to the A side or the B side of a pressure booster. The embodiment of the drive system with a 2Q-variable displacement pump disadvantageously requires more cost-intensive components, such as for example the variable displacement pump and a corresponding changeover valve (switching valve). Moreover, there are the usual drawbacks of a hydraulic drive system, such as throttling losses in the adjusting system and a large tank volume to be maintained for the large quantity of hydraulic fluid required. Moreover, the option of energy recovery is not provided.

The drive system with a 4Q-variable displacement pump differs, relative to the embodiment with the 2Q-variable displacement pump in terms of the pump, in that a pressure can be built up on the A side and on the B side of the 4Q-variable displacement pump and any volume flow can be activated between −Qₘₐₓ and +Qₘₐₓ. Thus, a hydrostatic transmission can be constructed with a correspondingly small oil tank volume and no additional changeover valve has to be provided. Such an embodiment is complex due to the pump displacement with a corresponding proportional valve (contains the required pump adaptation), cost-intensive and subject to losses due to the proportional valve.

### SUMMARY OF THE INVENTION

An object of the present invention is to specify a hydrostatic drive system and/or a method for producing a hydrostatic drive system which are suitable in each case for improving the prior art.

This invention features a hydrostatic drive system comprising at least one hydraulic cylinder with cylinder surfaces. The cylinder surfaces of the at least one hydraulic cylinder which are hydraulically connected to a constant pump (of the hydrostatic drive system) are configured to be of the same size. The hydrostatic drive system comprises the constant pump for pumping a volume flow. The constant pump is configured to provide at least two and at most three pumping states for pumping the volume flow as a corresponding volume flow. The hydrostatic drive system also comprises a switching device with a switching valve and a switching member, wherein a switching pressure is provided via the switching valve for switching the switching member. The switching member is configured, on the basis of the switching pressure, to switch the constant pump into one of the pumping states and to provide the corresponding volume flow to the hydraulic cylinder.

In some embodiments, the corresponding constant pump volume flow can be provided to the hydraulic cylinder. In particular, the volume flow is provided to the hydraulic cylinder via the ports of the constant pump. The switching member can be configured to activate the constant pump such that the constant pump provides the pumping states. In particular, the switching member can switch the corresponding switching pistons on the constant pump for providing the pumping states.

The term “hydrostatic drive system” as utilized herein refers to a hydraulic drive system which is configured to generate movements and a drive force by using a pressurized fluid. The fluid can comprise gases and liquids. The hydrostatic drive system is configured as a closed system in which the fluid remains in a closed circuit. Alternatively, it is possible to provide a semi-open system in which fluid can be supplied to the circuit via a fluid source.

The term “constant pump” as utilized herein refers to a hydraulic pump which can be used in hydraulic drive systems in order to provide a constant volume flow of a fluid, irrespective of changes in the system pressure or in the loading. A constant pump can provide a predefined quantity of hydraulic fluid for each revolution and does not change its pumping volume for each revolution. This is advantageous, in particular, in hydraulic systems in which a uniform liquid supply is required in order to control machine movements or other working processes in a constant and accurate manner. The constant pump can be configured as a piston pump or vane pump. The constant pump is actuated via an electric machine, for example an asynchronous machine. The constant pump has an A side and a B side via which a fluid-hydraulic connection can be provided between the constant pump and an actuator, for example a hydraulic cylinder. In particular, the surfaces of each chamber of the hydraulic cylinder can be connected in each case fluid-hydraulically to the A side or the B side of the constant pump via fluid lines. The constant pump can also provide at least two and at most three pumping states, comprising the provision of a maximum volume flow on the A side or the B side of the constant pump or a no-load volume flow in which no hydraulic fluid is provided on one of the two sides (ports) of the hydraulic cylinder.

The term “switching pressure” as utilized herein is a specific pressure which is provided via a switching valve in order to activate and/or switch the switching member of the constant pump. In particular, the switching pressure is the differential pressure which prevails between the two switching pistons of the switching member and is sufficient to switch the constant pump at the respective operating point from one pumping state into another pumping state, each pumping state having a corresponding volume flow.

The term “synchronized situation” is defined below.

In some embodiments, the switching pistons of the switching member are configured as single-acting hydraulic cylinders. The switching pistons are arranged opposingly in the constant pump. The switching pistons are designed to displace the stroke ring of the constant pump and thus to provide the volume flow of Qₘₐₓ+ to Qₘₐₓ− at the current speed of the electric machine, and vice versa. With a differential pressure value of zero, the springs in the switching member displace the stroke ring in the vicinity of the center in order to generate the third pumping state. For switching over the pumping state of the pump, the pressure difference between the two switching pistons of the switching member is significant. Other technical embodiments can also be provided for controlling the adjusting member of the constant pump in order to provide the maximum volume flow Qₘₐₓ+, Qₘₐₓ−. The use of a stroke ring for the constant pump in the above embodiment is not to be interpreted as limiting.

The above-described hydrostatic drive system provides a series of advantages. Amongst others is a good energy efficiency since the constant pump is directly connected to the hydraulic cylinder without friction elements potentially interposed in the flow, such as for example due to a directional valve. A more rapid and energy-efficient direction change can also be carried out by switching the displacement volume of the constant pump from positive to negative and vice versa. Thus, it is not necessary to change the rotational direction of the electric machine in order to change the direction of movement of an actuator or the hydraulic cylinder. The rotating parts of an electric machine, irrespective of the design, generally have an inertia which is increased by many times relative to the rotating parts of a hydraulic pump.

Moreover, the disclosed hydrostatic drive system is more energy-efficient since the drive system itself does not have to use any energy for braking and re-accelerating the drive shaft. The disclosed hydrostatic drive system is also more rapid since the inertia of the moving parts is lower, whereby a higher switching frequency can be achieved with the same performance being present. This is produced, in particular, relative to variable-speed constant pump drives. In comparison with conventional valve switching, the switching by means of a displacement volume change is more continuous, which can lead to the reduction of pressure surges and can act positively on the service life of the entire hydrostatic drive system. In comparison with conventional variable displacement pumps, the disclosed hydrostatic drive system requires no permanent provision of control pressure, which can increase the overall energy efficiency of the drive system. The noise emissions relative to the drive systems known from the prior art are also reduced, which is beneficial for working safety.

In some embodiments, the hydrostatic drive system is configured to transmit, by means of the hydraulic cylinder, a pressure from the hydrostatic drive system to a further mechanically connected system. Via the mechanical connection the force and/or the movement and/or the work of the hydraulic cylinder can be transmitted to the further system, and acts thereon. The further system can be configured as a test system.

In certain embodiments, mechanical connection can be implemented by a direct connection of the piston rod of the hydraulic cylinder to a mechanical component or a device of the further system, in order to transfer the mechanical work. For example, the piston rod of the hydraulic cylinder can be connected to a lever arm, a crankshaft or another device in order to generate a torque or a movement (vibration). Moreover, a toothed rack can be fastened to the hydraulic cylinder and a pinion or gearwheel can be used in order to convert the linear movement of the hydraulic cylinder into a rotational movement or vice versa. Moreover, a cable or wire cable can be connected to the piston of the hydraulic cylinder in order to transfer the force or movement to the further system (mechanical system). Moreover, different joints, couplings and connecting elements can be used in order to connect the piston rod of the hydraulic cylinder to other mechanical components of a further system.

As a result, significant forces can be generated and accurately controlled and transferred. Hydraulic systems also have a high degree of efficiency, in particular when it is a case of transferring forces over long distances or lifting heavy loads. Hydraulic systems are often very robust and durable, which makes them suitable for applications in harsh environments. Rapid and accurate controls can also be implemented, which permits a rapid movement reversal with a high degree of precision and reproducibility.

In some embodiments, the hydraulic cylinder has a connection to a second hydraulic cylinder (process cylinder) in order to provide a second pumping medium at a predeterminable pressure by means of the second hydraulic cylinder. The connection between the hydraulic cylinder and the second hydraulic cylinder can contain a mechanical connection or a fluid-hydraulic connection. Via the two hydraulic cylinders, a transfer of the pressure from the hydraulic cylinder to a different pressure can take place via the further hydraulic cylinder. Advantageously, via the second hydraulic cylinder a greater pressure or volume flow can be provided for downstream applications, for example.

In certain embodiments, the hydraulic cylinder is configured for providing a synchronized situation, and wherein the cylinder surfaces which are configured to be of the same size are forcibly coupled mechanically or hydraulically. The term “synchronized situation” is utilized herein to mean that the piston surfaces on both sides of the hydraulic cylinder (or a plurality of hydraulic cylinders) are of the same size and/or have the same effective area and that they are coupled together mechanically or hydraulically. A synchronized situation within the meaning of the disclosure with reference to the hydraulic cylinder also means that when a volume flow is supplied to a cylinder chamber of a hydraulic cylinder in a synchronized situation, an equal volume flow is removed from the other cylinder chamber of the hydraulic cylinder in the synchronized situation. The synchronized situation can be generated with a synchronized cylinder or from a combination of a plurality of hydraulic cylinders, which do not necessarily form a synchronized situation per se, such as for example a differential cylinder, but as a whole form the synchronized situation.

The hydraulic cylinder can be configured such that both the piston surface on one side and that on the other side are of the same size and have the same working area. Moreover, a mechanical or hydraulic forced coupling can be provided in which the piston surfaces are coupled together, either by the mechanical connection (for example via a common shaft or a rigid connection) or by hydraulic connections (for example by the use of lines and valves), in order to be able to ensure that they are moved in parallel and/or at the same time. In particular, it can be provided that the hydraulic or mechanical forced coupling takes place between two hydraulic cylinders and thus the surfaces thereof are coupled.

It can be provided that the two states of the constant pump comprise: a maximum positive volume flow Qₘₐₓ+ and a maximum negative volume flow Qₘₐₓ−. The third pumping state contains a resting state of the constant pump in which the hydrostatic drive system forces a no-load volume flow Q₀ for the hydraulic cylinder. Within the meaning of the disclosure, the third pumping state and the no-load volume flow Q₀ are generated and contained by the constant pump such that no volume flow is applied to the hydraulic cylinder.

In some embodiments, the constant pump can have two ports which are connected in each case to fluid lines A, B. In each case a maximum positive volume flow Qₘₐₓ+ or a maximum negative volume flow Qₘₐₓ− can be provided via one of the two ports. The maximum volume flow to be achieved is provided via the constant pump. Within the meaning of the present disclosure, the constant pump has a rotational direction. The output of the volume flow via the A side or the B side (line) of the constant pump is converted by switching the pumping states. Accordingly, a connected actuator, in particular a hydraulic cylinder, can be activated.

Moreover, the constant pump can be switched via the switching member into a state which contains a third pumping state with a no-load volume flow Q₀. In the third pumping state a maximum volume flow (positive or negative) is provided neither on the A side nor on the B side of the constant pump for activating the hydraulic cylinder. The third pumping state contains a slightly adjusted central position of the constant pump in which a defined volume flow (no-load volume flow Q₀) can be provided either on the A line or the B line of the constant pump. The third pumping state is advantageous in the adjusted central position in order to be able to switch from the pumping state with a no-load volume flow Q₀ into one of the states with a maximum volume flow.

It can be provided that the switching member comprises restoring springs and, if no switching pressure is applied, the restoring springs move the switching member into a third pumping state which corresponds to the no-load volume flow on the constant pump. The remaining volume flow of the constant pump can be discharged via the switching device, for example via the switching valve, so that the hydrostatic drive system generates a no-load volume flow Q₀ on the hydraulic cylinder. The switching member is configured to switch the constant pump into a state in which a maximum volume flow is provided to the constant pump via the port A or the port B. To this end, the switching member can be correspondingly started up/activated via a switching pressure and the constant pump switched. If no switching pressure is applied to the switching member, the switching member remains in a zero position (streamlined central position) and a no-load volume flow Q₀ is provided via the A side or B side of the constant pump.

It can be provided that the switching device is connected via fluid lines to the hydraulic cylinder or the hydraulic cylinder is configured with the switching device as a unit. The switching device can be configured as a unit which the constant pump encompasses with the switching member and the switching valve. The switching device can also comprise further units. The switching device can be connected fluid-hydraulically via fluid lines to the hydraulic cylinder. In this embodiment, the switching device and the hydraulic cylinder are configured as two components which are arranged at different positions and separately from one another. Alternatively, it can be provided that the hydraulic cylinder arranged on the switching device is configured as a unit. As a result, a compact design is achieved. It is also possible to dispense with additional fluid-hydraulic components for producing a connection.

It can be provided that a transfer between the maximum positive volume flow Qₘₐₓ+ and the maximum negative volume flow Qₘₐₓ− can be provided by means of the switching pressure. The transfer between the maximum positive volume flow and the maximum negative volume flow can take place continuously. Moreover, the transfer to the third pumping state can take place continuously. Due to the continuous transfer, the volume flow in the hydrostatic drive system can be frictionlessly and uniformly changed between different states or values without abrupt changes or impacts. The volume flow can be transferred gradually and continuously from a value, preferably a maximum value for the volume flow or a zero value, to another value without having to undergo sudden fluctuations or interruptions. As a result, a gentle control and accurate movement can be generated, in particular when it is a case of changing the direction or speed of movements. The noise emissions in the hydrostatic drive system are also reduced.

In some embodiments, the switching valve is configured as a 4/2-way switching valve. The 4/2-way switching valve can be configured as a hydraulic or pneumatic switching valve which is used in order to control the flow of liquids or gas in different directions. The 4/2-way switching valve has 4 ports and 2 switching positions. The 4/2-way switching valve can also be switched hydraulically, pneumatically, mechanically or electromechanically. Due to the use of a 4/2-way switching valve, it is possible to implement the two pumping states of the constant pump, comprising the positive maximum pumping volume flow Qₘₐₓ+ and the negative maximum pumping volume flow Qₘₐₓ−.

In certain embodiments, the switching valve is configured as a 4/3-way switching valve. The 4/3-way switching valve is a special type of hydraulic or pneumatic switching valve which is used in order to control the flow of liquids or gases in different directions. The 4/3-way switching valve has 4 ports and 3 switching positions. The 4/3-way switching valve can also be switched hydraulically, pneumatically, mechanically or electromagnetically. The three pumping states of the constant pump can be implemented by the use of a 4/3-way switching valve.

It can be provided that the switching valve can be switched via a pressure provided by the constant pump and/or a fluid source. The fluid source can be configured as an external fluid source or as a compensation tank. A flexible control of the hydrostatic drive system is made possible by the use of hydrostatic pressure for activating the switching valve. The switching valve can be switched and thereby the paths to the switching member opened or closed by changing the pressure in the hydraulic control lines of the switching valve in order to determine/switch the pumping state of the constant pump. This method of pressure control can be easily integrated in the disclosed hydrostatic drive system, since it is based on the prevailing pressure which is already present in the hydrostatic drive system. It requires fewer additional components or additional complex controls, which increases the cost-efficiency of the hydrostatic drive system. The use of the existing pressure for switching the switching valve can thus be configured to be cost-efficient. The pressure can also generally be provided from a constant pump or a fluid source in a stable and reliable manner. This can contribute to the switching valve operating reliably and fulfilling the desired functions. The use of the prevailing pressure can also improve the energy efficiency of the hydrostatic drive system, since no additional energy is required in order to actuate the switching valve.

Alternatively, it can be provided that the switching valve is designed so that it can be switched electromagnetically via control signals. To this end, it is possible to use a computing unit which can be provided for controlling the switching valve.

It can be provided that the switching pressure switched by the switching valve is provided from a compensation tank. Due to the use of a compensation tank, the switching pressure can be taken from a separate pressure source independently of the constant pump. Thus the flexibility in the configuration of the hydrostatic drive system can be increased and at the same time an adaptability of the pressure made possible, depending on requirements. Moreover, this generates a redundancy concept since the use of a plurality of pressure sources, including a constant pump and a compensation tank, can increase the reliability of the hydrostatic drive system. In the case of a malfunction of one pressure source, the other pressure source can serve as a back-up.

It can be provided that the switching pressure provided by the switching valve is provided by the constant pump. The highest pressure of the lines A, B and T of the constant pump is provided as switching pressure by a check valve to the switching valve which forwards the switching pressure to the switching member of the constant pump. The pumping volume flow can be switched thereby. This method for switching the constant pump can be easily integrated in the hydrostatic drive system since it is based on the prevailing pressure which is already present in the drive system. The use of the existing pressure for switching the constant pump can be cost-efficient since no additional pressure sources or complex controls are required as is the case in proportionally controlled variable displacement pumps.

Alternatively, the switching pressure provided by the switching valve can be provided from an external pump. Due to the use of an external pump, for example a gear pump, the switching pressure can be used independently of the constant pump. Thus the flexibility in the configuration of the hydrostatic drive system can be increased and at the same time a variation in the pressure made possible, depending on requirements. This also generates a redundancy since the use of a plurality of pressure sources, including the constant pump and the external pump, can increase the reliability of the hydrostatic drive system. In the case of a malfunction of one pressure source, the other pressure source can serve as a back-up.

It can be provided that the constant pump is configured as a 4Q-constant pump and comprises a piston pump and/or vane pump. Due the use of a 4-quadrant pump construction (4Q) the described hydraulic pump is able to operate with recuperative load cases and recover/recuperate energy with a suitable electrical system. Moreover, in a directional valve system the return of the hydraulic fluid has to be throttled in order to avoid an uncontrolled state. With a 4Q-constant pump this is not required, which leads to an increase in the efficiency. Moreover, the 4Q-constant pump has a higher degree of efficiency which can lead to a smaller requirement for hydraulic fluid and thus to a smaller ecological footprint.

It can be provided that the constant pump can be operated at a constant speed or a variable speed of an electric machine, preferably an asynchronous machine. The asynchronous machine can be automatically started without having to use external aids, such as a starter or external rotating field source. This can facilitate the start-up and the operation. Moreover, an asynchronous machine is robust with respect to load fluctuations and torque surges. It can be adapted to changing loads without losing synchronization. Asynchronous machines are also cost-effective in production and in operation.

It can be provided that the hydrostatic drive system comprises at least one safety valve. The actuator, preferably the hydraulic cylinder, can be disconnected from the ports of the constant pump via the safety valve. The piston of the hydraulic cylinder can thus be locked for ensuring the safety of the process. Alternatively, a safety valve can be used for short-circuiting the lines A, B of the constant pump in order to compensate for the difference in pressure between the lines and in order to protect the components of the hydrostatic drive system in the case of a fault. The two types of use of safety valves and combinations thereof can be used in the disclosed hydrostatic drive system.

It can be provided that the hydrostatic drive system comprises at least one pressure limiting valve. The pressure limiting valve can be used to protect the pressure at the ports A, B of the constant pump. As a result, the pressures at the ports of the constant pump cannot exceed the pressure predetermined by the pressure limiting valve. Thus, a protection of the components is achieved.

It can be provided that the hydrostatic drive system comprises at least one check valve. The check valve can be configured as an anti-cavitation valve in order to provide an anti-cavitation function of the constant pump and in order to avoid cavitation of the constant pump. The check valve can be connected on one side to a connection for a compensation tank and on the other side to the ports of the constant pump. Cavitation of the constant pump can be avoided by removing fluid from the compensation tank via a check valve.

As set forth above it can be provided that the hydrostatic drive system comprises at least one compensation tank. Fluid can be provided to the hydrostatic drive system via the compensation tank. The compensation tank can be configured as an open or closed reservoir. The oil compression volume can be provided via the compensation tank. The compensation tank also serves as a liquid reservoir for the hydrostatic drive system and together with the check valves ensures that the minimum suction pressure at the constant pump is maintained in all operating points, in order to prevent cavitation on the constant pump.

It can be provided that the hydrostatic drive system can be used for a stand-alone configuration or for semi-open configuration. Within the meaning of the disclosure, a stand-alone configuration represents a self-contained hydrostatic drive system in which a preloading is present. Thus, no further components (fluid source, reservoir) are required for building up a pressure, but the hydraulic components which are used can be designed for the pressure in the hydrostatic drive system, which can lead to greater complexity and costs.

A semi-open configuration comprises the use of a fluid source and/or a reservoir via which fluid can be supplied to the hydrostatic drive system. A complex design of the components is not required and a very effective cooling and filtering can be implemented.

In other words, that described above can be combined to form a potentially more specific embodiment of the disclosure as described below, wherein the following description can be designed to be non-limiting for the disclosure. Here it is proposed to use a constant pump and to switch this constant pump via a zero pumping volume. This permits the combination of the advantages of the drive system with a 2Q-constant pump combined with a changeover valve and a drive system with a 4Q-variable displacement pump, whilst at the same time minimizing the drawbacks of the solutions known from the prior art. The basis can form a 4Q-constant pump, the pumping volume Vₘₐₓ+, Vₘₐₓ− thereof being selected via a switching valve. Since both ports of the pump can be pressurized, firstly the changeover valve of the hydrostatic drive system with the 2Q-constant pump can be dispensed with and secondly the use of an expensive and complex variable displacement pump can be avoided. It is also proposed to design the constant pump with a compact interface in order to integrate directly a control block with the required hydraulic functions, such as for example an anti-cavitation function and pressure accumulator, in a very compact manner and thus keep the fluid volume in the facility as small as possible. In principle, impacts and vibrations are substantially reduced, since a continuous transfer from the pumping volume Vₘₐₓ+ to Vₘₐₓ− is provided inside the pump. The volume flow to the actuator ports of the hydrostatic drive unit can be switched off by the switching valve for the pumping volume position Vₘₐₓ+ to Vₘₐₓ− being switched to its central position (no-load).

The 4Q-constant pump can be switched via zero pumping volume in order to select the volume flow of Qₘₐₓ+ to Qₘₐₓ− and Q₀. The speed of the constant pump is constant or variable, preferably by means of an asynchronous machine. This machine can optionally obtain a quasi-static speed adaptation by means of a frequency converter. A 4Q-pump compact interface can be provided for a direct flange-connection of a control block or synchronous cylinder. It is possible to provide, by means of the specific embodiment, a simple, advantageous hydrostatic drive system without any impacts.

Moreover, an application system comprising the disclosed hydrostatic drive system for providing a pressurized medium is provided. The application system, also referred to herein as a high-pressure fluid delivery system, can contain a pressure booster and can be used as a test system for dynamic test applications, for water jet cutting, for metering applications with metering pumps, applications with pumps for high density materials, for applications with hot isostatic pressing (HIP) and cold isostatic pressing (CIP), applications for hydroforming (water and oil), applications with a high-pressure requirement, applications for gas boosters and/or autofrettage.

The rapid switching of the direction of movement achieved by means of the disclosed hydrostatic drive system can lead to lower process pressure losses in a pressure booster application. Thus, an improved pumping quality can be achieved in the applications, such as for example in water jet cutting. A continuous process pressure also acts positively on the life expectancy of the entire hydrostatic drive system.

The hydrostatic drive system, in particular, is suitable for test applications with a high-frequency reciprocating movement of a piston, for example in pressure boosters. A dual variable displacement pump with variable speed, which can be switched via zero pumping volume, is particularly suitable for oscillating applications such as piston pumps and pressure booster applications. These applications require a rapid reversal of the cylinder piston movement and a quasi-static speed control.

That described above with reference to the hydrostatic drive system according to the present invention also applies to application systems according to the present invention, and vice versa.

Moreover, a method is provided for producing a hydrostatic drive system comprising at least one hydraulic cylinder with cylinder surfaces, wherein the cylinder surfaces of the at least one hydraulic cylinder, which are hydraulically connected to a constant pump, are configured to be of the same size. The method comprises providing the constant pump for pumping a volume flow, wherein the constant pump is configured to provide at least two and at most three pumping states for pumping the volume flow. Moreover, the method comprises providing a switching device with a switching valve and a switching member, wherein a switching pressure is provided via the switching valve for switching the switching member. The method also comprises configuring the switching member such that, on the basis of the switching pressure, the constant pump switches to one of the pumping states and provides a volume flow to the hydraulic cylinder.

That described above relative to the hydrostatic drive system and the application system also applies to the method and vice versa. The above embodiments and developments can be combined in any manner, if expedient. Further possible embodiments, developments and implementations of the disclosure also encompass not explicitly mentioned combinations of features of the disclosure described above or below relative to the exemplary embodiments. In particular, a person skilled in the art also will add individual aspects as improvements or additions to the respective basic form of the present disclosure.

### BRIEF DESCRIPTION OF THE DRAWINGS

To enable a better understanding of the present invention, and to show how the same may be carried into effect, certain embodiments of the invention are explained in more detail with reference to the drawings, by way of example only, in which:

FIG. 1 is a schematic diagram of a hydrostatic drive system according to the present invention;

FIG. 2 is a schematic diagram of a further embodiment of the disclosed hydrostatic drive system;

FIG. 3 is a schematic diagram of a further embodiment of the disclosed hydrostatic drive system; and

FIG. 4 is a schematic diagram of a further embodiment of the disclosed hydrostatic drive system.

### DETAILED DESCRIPTION OF THE PRESENTLY PREFERRED EMBODIMENTS

The accompanying drawings are intended to provide greater understanding of the embodiments of the disclosure. They illustrate embodiments and serve in combination with the description to explain principles and concepts of the disclosure. Further embodiments and many of the aforementioned advantages are found with reference to the drawings. The elements of the drawings are not necessarily shown to scale relative to one another. Elements, features and components which are the same, functionally the same and have the same effect—unless specified otherwise—are provided in each case with the same reference signs in the figures of the drawing.

This invention may be accomplished by a hydrostatic drive system, and methods of making and using same, including a constant pump configured to provide at least two and at most three pumping states for pumping a volume flow. A switching device has a switching valve and a switching member, wherein a switching pressure is provided via the switching valve for switching the switching member, and wherein the switching member is configured, on the basis of the switching pressure, to switch the constant pump into one of the pumping states and to provide a volume flow to the hydraulic cylinder.

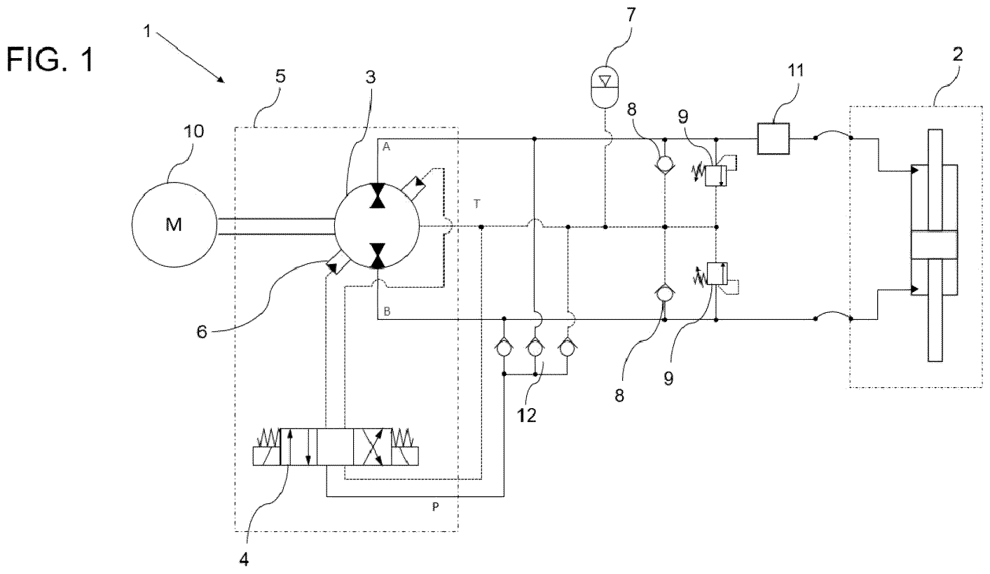

FIG. 1 shows a schematic view of a hydrostatic drive system 1 according to one embodiment. The hydrostatic drive system 1 has a hydraulic cylinder 2 and a constant pump 3. The hydraulic cylinder 2 has cylinder surfaces. The cylinder surfaces of the hydraulic cylinder 2 which are hydraulically connected to the constant pump 3 are configured to be of the same size. Thus, a synchronous movement can be performed. The hydraulic cylinder 2 is fluidically connected to the ports A, B of the constant pump 3. The corresponding lines at the ports A, B of the constant pump 3 can also be regarded/denoted as lines A, B.

The constant pump 3 is configured for pumping a volume flow of a fluid. The fluid can comprise a hydraulic fluid or a gaseous fluid. The constant pump 3 can be driven via an electric machine 10 at a constant speed or variable speed. The electric machine 10 can be configured as an asynchronous motor. The electric machine 10 can be connected, for example, via a shaft to the constant pump 3 and correspondingly drive this constant pump. Further embodiments of the electric machine 10 can be used according to the application case. The constant pump 3 can be configured as a 4Q-constant pump. The constant pump 3 can also comprise a piston pump or a vane pump.

The constant pump 3 is configured to provide at least two pumping states for pumping the volume flow. Moreover, the constant pump 3 is configured to provide at most three pumping states for pumping the volume flow. The two pumping states of the constant pump 3 for pumping the volume flow comprise a maximum positive volume flow Qₘₐₓ+, and a maximum negative volume flow Qₘₐₓ−. The maximum positive volume flow Qₘₐₓ+ and the maximum negative volume flow Qₘₐₓ− are provided via the ports A, B of the constant pump 3 and via the lines A, B to the hydraulic cylinder 2. In a third pumping state of the constant pump 3 a no-load volume flow Q₀ for the hydraulic cylinder 2 can be forced via the hydrostatic drive system 1.

Moreover, a switching device 5 is provided. The switching device 5 has the switching valve 4 and a switching member 6. In the embodiment of FIG. 1, the constant pump 3 is shown arranged so as to form part of the switching device 5. The switching valve 4 has a fluid connection to the switching member 6. In particular, the switching valve 4 has a fluid connection to the switching piston of the switching member 6. The switching valve 4 also has a fluid connection P to at least one check valve 12 and the line or the port T of the constant pump 3. Moreover, the switching device 5 can have the check valves 8, the pressure limiting valves 9, the safety valve 11 and/or the further check valves 12. The schematic view of the switching device 5 in FIG. 1 is not limiting for the embodiment of the switching device 5. A switching pressure is provided via the switching valve 4 for switching the switching member 6. The switching valve 4 can be configured as a 4/2-way switching valve or as a 4/3-way switching valve.

The switching valve 4 can be actuated hydraulically, mechanically, pneumatically or electromagnetically. The aforementioned actuations are non-limiting here. Rather, it is known to a person skilled in the art that a switching valve can have other switching embodiments. To this end, the pressure provided by the hydrostatic drive system 1 and the constant pump 3 can be used and the switching valve 4 can be switched via the pressure provided, in particular a fluid pressure. Alternatively or additionally, it is possible to provide a fluid source via which a fluid pressure is provided for switching the switching valve 4. According to FIG. 1, the switching valve 4 is provided as a switching valve with an electromagnetic control for switching the switching valve 4. The switching valve 4 can receive control signals from a control device, for example a computer, SPS, etc. or sensors, and can be switched to the corresponding switching position on the basis of the control signals. According to the switching position of the switching valve 4, the switching member 6 is hydraulically activated and switches the constant pump 3 for providing a maximum volume flow (positive or negative) or into a third pumping state of the constant pump.

The switching member 6 is configured, on the basis of the switching pressure, to switch the constant pump 3 into one of the pumping states and thus provide the corresponding volume flow of the constant pump 3 via the ports A, B to the hydraulic cylinder 2. The switching member 6 is configured in one piece with the constant pump 3 and switches the constant pump 3 into one of the pumping states. The switching member 6 switches the constant pump 3 such that a maximum positive volume flow Qₘₐₓ+ is provided at one of the ports A, B of the constant pump 3 or a maximum negative volume flow Qₘₐₓ− is provided at one of the ports A, B of the constant pump 3. For example, a maximum positive volume flow Qₘₐₓ+ can be provided at the port A of the constant pump 3 by a correspondingly provided switching pressure. The correspondingly returned volume flow is received via the port B. When switching the switching pressure, a maximum negative volume flow Qₘₐₓ− can be provided at the port B of the constant pump 3 and the correspondingly returned volume flow is received via the port A. A switching of the constant pump 3 is brought about by a corresponding switching of the switching pressure, whereby the direction of flow of the volume flow at maximum volume flow is changed.

A transfer between the positive volume flow Qₘₐₓ+ and the maximum negative volume flow Qₘₐₓ− is provided by means of the switching pressure provided by the switching valve 4. The transfer from the maximum positive volume flow Qₘₐₓ+ to the maximum negative volume flow Qₘₐₓ− takes place continuously. The resulting pumping volume flow has the continuous transfer from Qₘₐₓ+ to Qₘₐₓ−.

Moreover, the switching member 6 has restoring springs. The restoring springs represent a mechanical switching of the switching member 6 which can force the constant pump 3 into the third pumping state. This means that, if no switching pressure is provided via the switching valve 4 to the switching member 6, the restoring springs move the switching member 6, in particular mechanically, into a zero position (streamlined central position) in order to force a third pumping state by the constant pump 3. In the third pumping state at the ports A, B of the constant pump 3 a no-load volume flow is forced for the hydraulic cylinder 2.

It is provided that the switching pressure switched by the switching valve 4 is provided from the compensation tank 7 and/or via the constant pump 3 itself. The switching pressure to be switched is provided via the check valves 12. In addition and/or alternatively, an external pump (not shown) can be provided. The external pump can be connected in a fluid-conducting manner via the P line to the switching valve 4 and provide the switching pressure to be switched.

The hydrostatic drive system 1 has at least one safety valve 11. In the embodiment shown, the safety valve 11 is incorporated in the fluid line A starting from the port A of the constant pump 3 to the hydraulic cylinder 2. Via the safety valve 11, at least one of the hydraulic cylinders 2 can be disconnected from the hydrostatic drive system 1, in order to ensure the safety of the process, by the movement of the piston of the hydraulic cylinders 2 being prevented by shutting off the fluid lines A (or B when incorporated in the line B) from the hydraulic cylinders 2. Moreover, the constant pump 3 can be short-circuited via a safety valve 11 in order to ensure a pressure compensation via the lines A and B. This serves as component protection. The two types of use of the safety valve 11 and the combinations of the two can be used in the disclosed hydrostatic drive system 1. Moreover, the hydrostatic drive system 1 has at least one pressure limiting valve 9. In the embodiment of FIG. 1 shown, a corresponding pressure limiting valve 9 is provided for each port A, B of the constant pump 3. The pressure limiting valve 9 is incorporated by the line A connected to the line T. A further pressure limiting valve 9 is incorporated by the line T connected to the line B. Moreover, the hydrostatic drive system 1 has at least one check valve 8 in each line of the ports A, B of the constant pump 3. The check valve 8 is incorporated by the line A connected in the shut-off direction to the line T. A further check valve 8 is incorporated by the line T connected in the through-flow direction to the line B. An anti-cavitation function of the constant pump 3 can be provided via the check valve 8 in order to minimize cavitation. A compensation tank 7 is also provided. The oil compression volume is provided via the compensation tank 7.

Moreover, the constant pump 3 has a further port which leads into the node point T of the line T. The preload pressure which is provided via the compensation tank 7 is applied at the node point T. Also in the embodiment of FIG. 1, the constant pump 3 has an internal coupling of the housing with the line at the node point T. This results in a closed system, whereby there is no need for an external supply of fluid. The preload pressure can be provided to the switching valve 4 via the check valves 12. The three check valves 12 shown in FIG. 1 have in each case a connection to the lines A, B, T and a common connection to the switching valve 4 via the line P. The pressure of the ports A, B of the constant pump 3 is also applied to the switching valve 4.

In one embodiment, the switching device 5 is connected via fluid lines to the hydraulic cylinder 2. The switching device 5 can be configured as a separate block which is positioned independently of the hydraulic cylinder 2 and an application system. Alternatively, the hydraulic cylinder 2 can be configured with the switching device 5 as a unit. In this embodiment, the hydraulic cylinder 2 is flange-connected to the block comprising the switching device 5, the constant pump 3 and optionally the electric machine 10, and thus is configured in one piece.

It is provided that the hydraulic cylinder 2 is configured for providing a synchronized situation. To this end, the hydraulic cylinder 2 has cylinder surfaces which are configured to be of the same size. In the embodiment of FIG. 1 shown, the hydraulic cylinder 2 has two cylinder surfaces of the same size and coupled mechanically together via a piston rod.

The hydrostatic drive system 1 can be used for providing a pressurized medium. The hydrostatic drive system 1 is configured to transmit, by means of the hydraulic cylinder 2, a pressure from the hydrostatic drive system 1 to a further, mechanically connected system, for example as a pressure booster. Moreover, it can be provided that the hydraulic cylinder 2 has a connection to a second hydraulic cylinder in order to provide a second pumping medium at a predeterminable pressure by the second hydraulic cylinder.

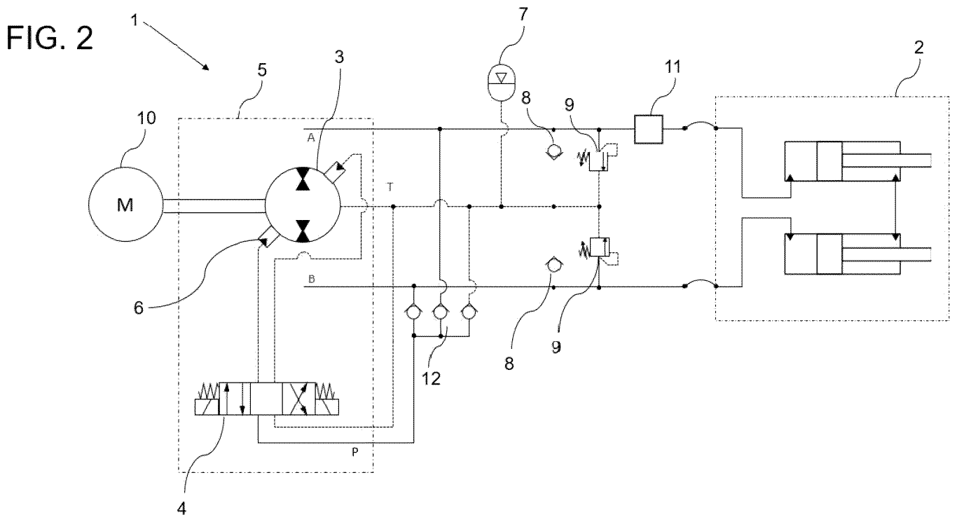

FIG. 2 schematically shows a further embodiment of the disclosed hydrostatic drive system 1. The hydrostatic drive system 1 of FIG. 2 is designed in the same manner as the embodiment shown in FIG. 1. The hydrostatic drive system 1 shown in FIG. 2 has, alternatively to FIG. 1, a first and a second hydraulic cylinder 2 which are forcibly coupled together hydraulically. By pumping a maximum positive volume flow Qₘₐₓ+ via the port A of the constant pump 3, for example, the upper hydraulic cylinder 2 is extended and the fluid on the piston side is pumped into the lower hydraulic cylinder 2 and a retraction movement of the lower hydraulic cylinder 2 is brought about. This results in a hydraulic forced coupling. The cylinder surfaces are configured to be of the same size, whereby a synchronized situation is present. This embodiment can be advantageous, for example, in pressure booster applications and applications with pumps for high density materials in which the installation space is limited, such as for example in concrete pumps. Applications with limited installation space can thus occur in which the length of the synchronous cylinder is not acceptable, for example. A further use can be implemented in application systems in which the process limits the installation space and a certain flexibility is required.

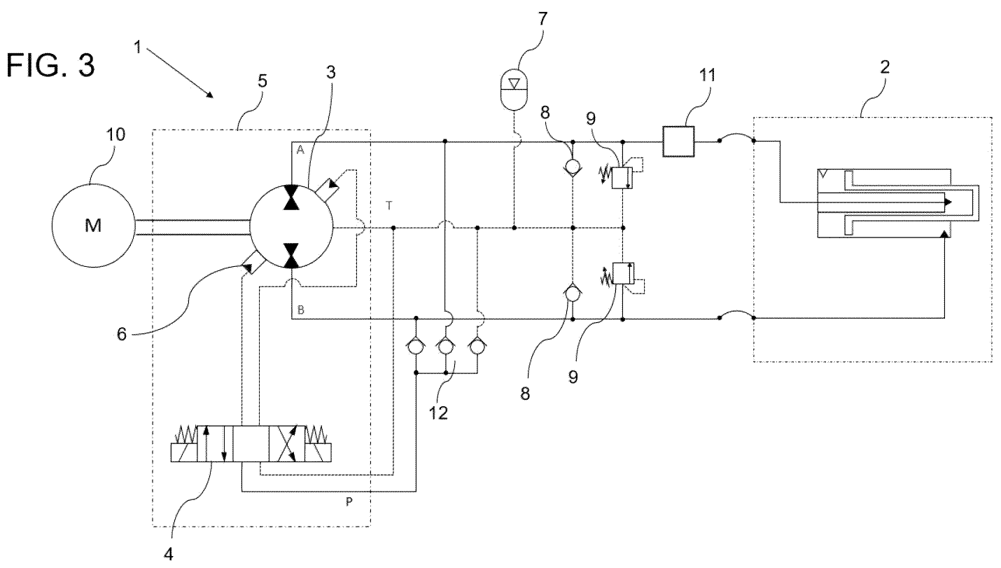

FIG. 3 schematically shows a further embodiment of the disclosed hydrostatic drive system 1. The hydrostatic drive system 1 of FIG. 3 is designed in the same manner as the embodiments shown in FIGS. 1 and 2. The hydraulic cylinder 2 of FIG. 3 differs from the hydraulic cylinder of the embodiment according to FIGS. 1 and 2 in that this hydraulic cylinder has cylinder surfaces of the same size which are forcibly coupled together mechanically and in which a synchronized situation is present. A particularity of the hydraulic cylinder 2 shown in FIG. 3 is that, while it fulfils a synchronized situation, it has only one retractable and extendable piston rod. A compact embodiment of the hydraulic cylinder 2 can be achieved thereby. This embodiment can be advantageous, for example, in test applications with limited installation space with a long stroke, such as for example a fatigue test stand for aircraft wings.

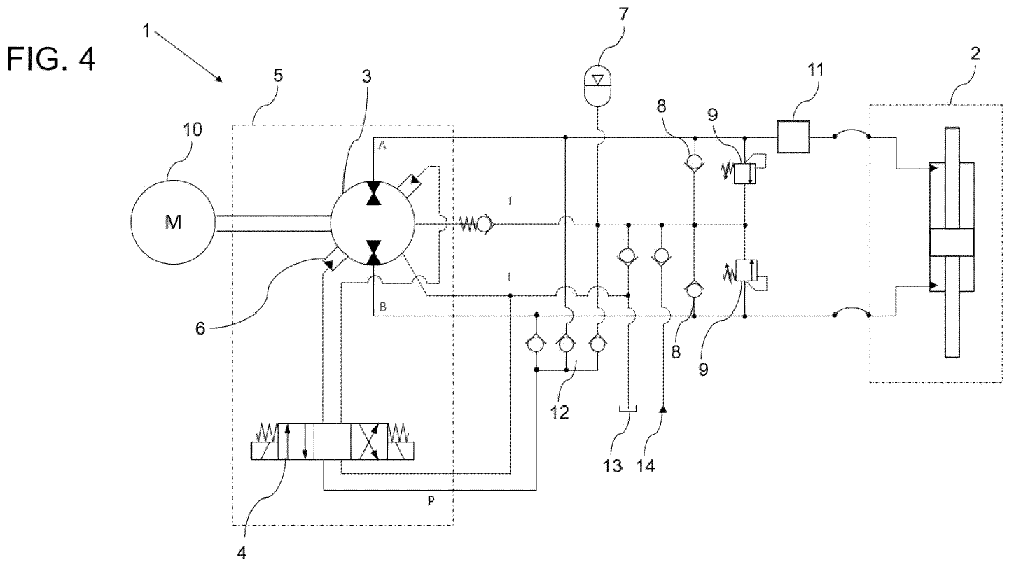

FIG. 4 schematically shows a further embodiment of the disclosed hydrostatic drive system 1. The hydrostatic drive system 1 according to FIG. 4 has an external fluid source 14 and a reservoir 13 in addition to the components of the embodiments of FIGS. 1 to 3. In the embodiment of FIG. 4, the preload pressure at the node point T is provided via the external fluid source 14 (for example a pump). A constant pressure of the fluid can be provided via the external fluid source 14. Moreover, a reservoir 13 is provided. The reservoir 13 is configured as an open reservoir. The reservoir 13 is fluidically connected to the housing of the constant pump 3 by means of a fluid line via the node point L. Thus, the preload pressure at the node point T can be provided via the external fluid source 14. The preload pressure can be switched to the line P via the further check valves 12 and thus switched by the switching valve 4 and the switching member 6 of the constant pump 3.

In FIG. 4 the hydrostatic drive system 1 is shown with a hydraulic cylinder 2 according to FIG. 1. This does not exclude the use of the hydraulic cylinder 2 according to FIGS. 2 and 3. Rather, the hydraulic cylinder 2 as shown in FIGS. 2 and 3 can be operated by the hydrostatic drive system 1 of FIG. 4.

The embodiments shown in FIGS. 1 to 4 of the hydrostatic drive system 1 can be produced by the disclosed method. Moreover, the embodiments of the hydrostatic drive system 1 shown in FIGS. 1 to 4 can be used for the disclosed application system.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is the intention, therefore, to be limited only as indicated by the scope of the claims appended hereto. Other embodiments will occur to those skilled in the art after reviewing the present disclosure and are within the following claims.

What is claimed is:

1. A hydrostatic drive system comprising:
at least one hydraulic cylinder with cylinder surfaces, wherein the cylinder surfaces of the at least one hydraulic cylinder which are hydraulically connected to a constant pump are configured to be of the same size;
the constant pump for pumping a volume flow, wherein the constant pump is configured to provide at least two and at most three pumping states for pumping the volume flow as a corresponding volume flow;
a switching device with a switching valve and a switching member, wherein a switching pressure is provided via the switching valve for switching the switching member; and
wherein the switching member is configured, on the basis of the switching pressure, to switch the constant pump into one of the pumping states and to provide the corresponding volume flow to the hydraulic cylinder.

2. The hydrostatic drive system of claim 1, wherein the hydrostatic drive system is configured to transmit, by means of the hydraulic cylinder, a pressure from the hydrostatic drive system to a mechanically connected system.

3. The hydrostatic drive system of claim 1, wherein the hydraulic cylinder has a connection to a second hydraulic cylinder in order to provide a second pumping medium with a predeterminable pressure by the second hydraulic cylinder.

4. The hydrostatic drive system of claim 1, wherein the hydraulic cylinder is configured to provide a synchronized situation and wherein the cylinder surfaces which are configured to be of the same size are forcibly coupled mechanically or hydraulically.

5. The hydrostatic drive system of claim 1, wherein the at least two states of the constant pump include a maximum positive volume flow Qₘₐₓ+, and a maximum negative volume flow Qₘₐₓ−.

6. The hydrostatic drive system of claim 5, wherein the third pumping state forces a no-load volume flow Q₀ for the hydraulic cylinder.

7. The hydrostatic drive system of claim 1, wherein the switching member comprises restoring springs and, if no switching pressure is applied, the restoring springs move the switching member into a zero position in order to force the no-load volume flow Q₀.

8. The hydrostatic drive system of claim 1, wherein the switching device is connected via fluid lines to the hydraulic cylinder or the hydraulic cylinder is configured with the switching device as a unit.

9. The hydrostatic drive system of claim 1, wherein a transfer between the maximum positive volume flow Qₘₐₓ+ and the maximum negative volume flow Qₘₐₓ− can be provided by means of the switching pressure.

10. The hydrostatic drive system of claim 1, wherein the switching valve is configured as a 4/2-way switching valve or a 4/3-way switching valve.

11. The hydrostatic drive system of claim 1, wherein the switching valve can be switched via a pressure provided by the constant pump and/or by a fluid source, or can be switched electromagnetically via control signals.

12. The hydrostatic drive system of claim 1, wherein the switching pressure switched by the switching valve is provided from a compensation tank and/or via the constant pump and/or via an external pump.

13. The hydrostatic drive system of claim 1, wherein the constant pump is configured as a 4Q-constant pump and comprises a piston pump or vane pump.

14. The hydrostatic drive system of claim 1, wherein the constant pump can be operated at a constant speed or a variable speed of an electric machine, preferably an asynchronous machine.

15. The hydrostatic drive system of claim 1, wherein the hydrostatic drive system includes at least one safety valve.

16. The hydrostatic drive system of claim 1, wherein the hydrostatic drive system includes at least one pressure limiting valve and/or at least one check valve.

17. A method for producing a hydrostatic drive system, comprising:
selecting at least one hydraulic cylinder with cylinder surfaces, wherein the cylinder surfaces of the at least one hydraulic cylinder which are hydraulically connected to a constant pump are configured to be of the same size;
selecting the constant pump for pumping a volume flow, wherein the constant pump is configured to provide at least two and at most three pumping states for pumping a corresponding volume flow;
selecting a switching device with a switching valve and a switching member, wherein a switching pressure is provided via the switching valve for switching the switching member; and
configuring the switching member such that, on the basis of the switching pressure, the constant pump switches into one of the pumping states and provides the corresponding volume flow to the hydraulic cylinder.
